(19) United States
(12) Patent Application Publication
(10) Pub. No.: US 2014/0339753 A1
(43) Pub. Date: Nov. 20, 2014

(54) ELECTRIC CLAMP APPARATUS

(71) Applicant: SMC KABUSHIKI KAISHA, Chiyoda-ku, Tokyo (JP)

(72) Inventors: Chiaki Fukui, Abiko-shi (JP); Noriyuki Miyazaki, Kashiwa-shi (JP)

(73) Assignee: SMC KABUSHIKI KAISHA, Chiyoda-ku, Tokyo (JP)

(21) Appl. No.: 14/369,852

(22) PCT Filed: Oct. 11, 2012
(86) PCT No.: PCT/JP2012/076872

§ 371 Date: Jun. 30, 2014

(30) Foreign Application Priority Data
Jan. 27, 2012 (JP) 2012-015331

(51) Int. Cl. B25B 5/12

(52) U.S. Cl. CPC B25B 5/12
USPC 269/228

(57) ABSTRACT

An electric clamp apparatus includes a body, a rotary drive unit which is driven rotatably by an electric signal, a drive force transmission mechanism for transmitting a rotary drive force of the rotary drive unit to a toggle link mechanism, and a clamp arm disposed rotatably with respect to the body. By driving the rotary drive unit, a drive force is transmitted to the clamp arm through the drive force transmission mechanism, whereby the clamp arm is rotated through a predetermined angle with respect to the body, and a workpiece is clamped between the clamp arm and a support member of the body. At this time, an adjustment mechanism disposed on the clamp arm includes a rod, which advances and retracts so as to stably clamp workpieces of different plate thicknesses.

### TECHNICAL FIELD

The present invention relates to an electric clamp apparatus, which is capable of clamping a workpiece on an automated assembly line or the like.

### BACKGROUND ART

Heretofore, in an automated assembly line for automobiles, an assembly process has been carried out in which clamping is performed by a clamp apparatus under a condition in which preformed body panels are positioned in an overlaid manner and the body panels are welded together.

The present applicant has proposed an electric clamp apparatus as disclosed in Japanese Laid-Open Patent Publication No. 2001-105332. The electric clamp apparatus is equipped with a body, a rotary drive unit disposed in the interior of the body, and a clamp arm, which projects outwardly with respect to the body. By transmitting a rotary drive force of the rotary drive unit to a ball screw mechanism, the clamp arm is operated through a toggle link mechanism so as to rotate through a predetermined angle for clamping a workpiece or the like, for example.

### SUMMARY OF INVENTION

A general object of the present invention is to provide an electric clamp apparatus in which a stable clamping force can always be obtained without requiring adjustment operations to be performed on a clamp arm, together with enabling various workpieces of different thicknesses to be clamped in a stable manner.

The present invention is an electric clamp apparatus for gripping a workpiece with a rotary clamp arm, comprising a body, a drive unit which is driven rotatably by an electric signal, a transmission mechanism for transmitting a rotary drive force of the drive unit, a feed screw mechanism for converting rotational motion transmitted by the transmission mechanism into linear motion, a toggle link mechanism for converting the linear motion transmitted by the feed screw mechanism into a rotary operation of the clamp arm, and an adjustment mechanism for adjusting a clamping position by the clamp arm corresponding to a thickness of the workpiece.

According to the present invention, the adjustment mechanism is provided, which is capable of adjusting a clamping position of the clamp arm responsive to the thickness of the workpiece, so as to grip the workpiece with a predetermined gripping force. Thus, for example, even in the case that workpieces of different thicknesses are to be gripped, there is no need to adjust the toggle link mechanism each time that the plate thickness of the workpiece is changed, so that clamping of workpieces can reliably and stably be performed merely by adjusting the clamping position by means of the adjustment mechanism.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF DRAWINGS

FIG. 1 is an overall cross sectional view showing an electric clamp apparatus according to a first embodiment of the present invention;

FIG. 2 is an overall cross sectional view showing a condition in which a clamp arm in the electric clamp apparatus of FIG. 1 is rotated through a predetermined angle;

FIG. 3 is an overall cross sectional view showing a clamped state in which the clamp arm in the electric clamp apparatus of FIG. 2 is rotated further;

FIG. 4 is a plan view with partial omission of the electric clamp apparatus of FIG. 1 as viewed from below; and

FIG. 5 is an enlarged cross sectional view showing a clamped state in the electric clamp apparatus of FIG. 4, in which a workpiece having a large plate thickness is clamped.

### DESCRIPTION OF EMBODIMENTS

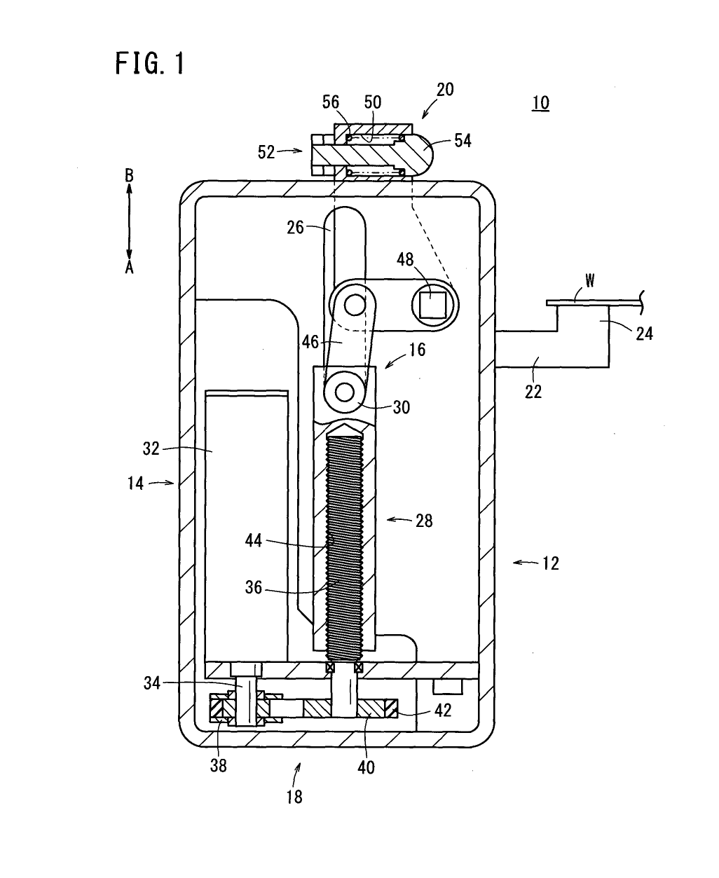

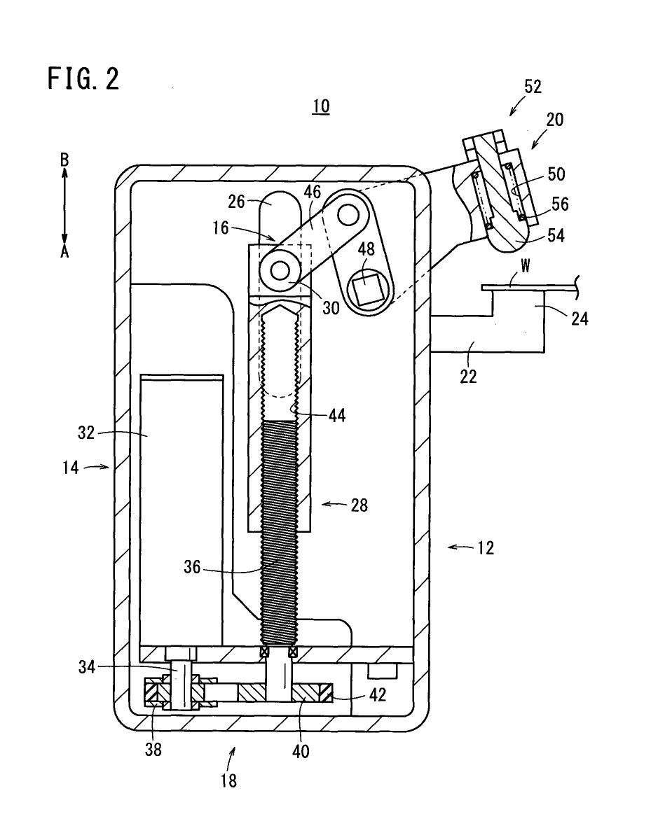

As shown in FIGS. 1 through 3, an electric clamp apparatus 10 includes a body 12, a rotary drive unit 14 disposed in the interior of the body 12, a drive force transmission mechanism (transmission mechanism) 18 for transmitting a rotary drive force of the rotary drive unit 14 to a toggle link mechanism 16, and a clamp arm 20 disposed rotatably with respect to the body 12.

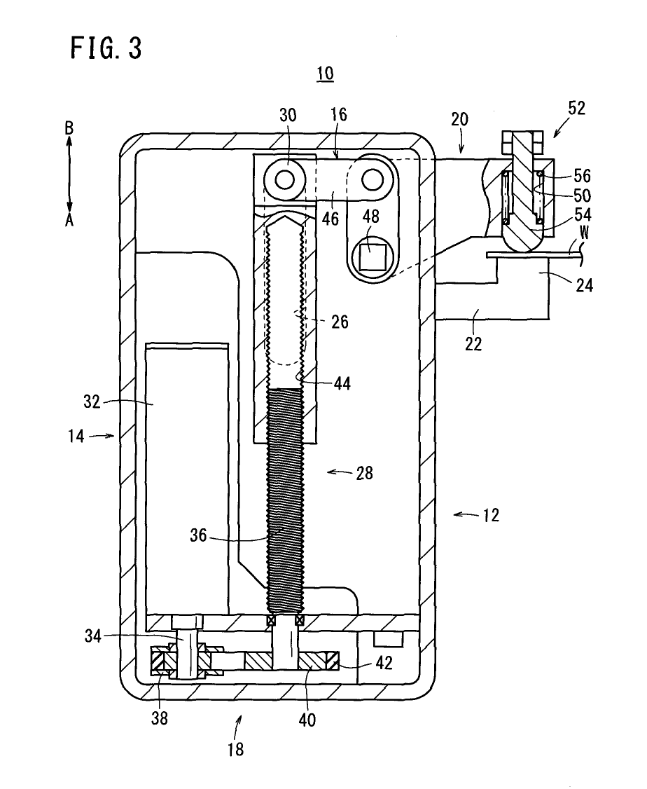

The body 12, for example, is hollow and is formed with an elongate substantially rectangular shape in cross section extending in a vertical direction (the direction of arrows A and B). A support member 22 is provided, which projects laterally on an upper portion of the body 12. The support member 22 projects outwardly in a horizontal direction having a predetermined length with respect to a side surface of the body 12, and is formed on the end thereof with a gripping section 24, which projects upwardly. Additionally, as shown in FIG. 3, at a time of clamping when the clamp arm 20 is rotated, a workpiece W is clamped between the clamp arm 20 and the support member 22.

A roller groove 26, which extends in a vertical direction (the direction of arrows A and B), is formed in a substantially central portion of the body 12. Rollers 30, which are provided on a later-described displacement body 28, are inserted in and guided by the roller groove 26.

The rotary drive unit 14 is made up, for example, from a rotary drive source 32 such as an induction motor, a brushless motor, or the like, which is driven rotatably by an electric signal that is input thereto. The rotary drive source 32 is disposed along a vertical direction of the body 12 (the direction of arrows A and B), with a drive shaft 34 thereof being arranged in a downward direction (in the direction of the arrow A).

The drive force transmission mechanism 18 includes a feed screw shaft 36, which is disposed rotatably in a substantially central portion of the body 12, a drive pulley 38 connected to the drive shaft 34 of the rotary drive source 32, a driven pulley 40, which is connected to a lower end of the feed screw shaft 36, a transmission belt 42 trained between the drive pulley 38 and the driven pulley 40, and the displacement body 28, which is screw-engaged with an outer circumferential side of the feed screw shaft 36.

The feed screw shaft 36 is an axial body having a predetermined length, which is arranged to extend in a vertical direction (the direction of arrows A and B) in the interior of the body 12. Upper and lower ends of the feed screw shaft 36 are supported rotatably with respect to the body 12. Further, screw grooves are formed in a helical shape on the outer circumferential surface of the feed screw shaft 36, and the feed screw shaft 36 is disposed in parallel with the rotary drive unit 14 in the interior of the body 12.

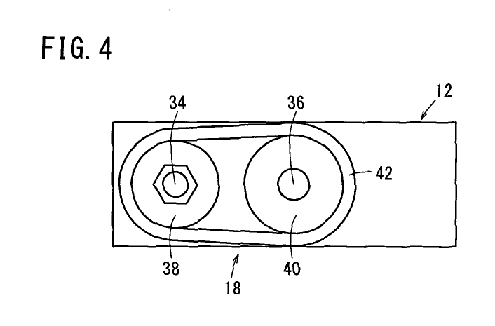

As shown in FIG. 4, the drive pulley 38 and the driven pulley 40 are shaped respectively as disks, and are disposed at the same height so that mutual outer circumferential surfaces thereof face toward one another (see FIG. 1). In addition, the transmission belt 42 is trained around respective outer circumferential surfaces of the drive pulley 38 and the driven pulley 40, such that by driving the rotary drive unit 14, the drive pulley 38 is rotated, and the rotational force thereof is transmitted through the transmission belt 42 to the driven pulley 40, whereby the driven pulley 40 and the feed screw shaft 36 are rotated together in unison.

The displacement body 28 is formed in a cylindrical shape with a predetermined length along the axial direction (the direction of arrows A and B). Female screw threads 44, which are formed on an interior portion of the displacement body 28, are screw-engaged with the feed screw shaft 36. More specifically, the feed screw shaft 36 is inserted into the interior of the displacement body 28 and is held in threaded engagement therewith. Additionally, the displacement body 28 is moved in the axial direction (the direction of arrows A and B) by rotation of the feed screw shaft 36.

Further, a pair of the rollers 30 is provided rotatably on the upper part of the displacement body 28. By insertion of the rollers 30 in the roller groove 26 of the body 12, the displacement body 28 is guided in a vertical direction (the direction of arrows A and B) upon movement thereof, whereas rotational displacement of the displacement body 28 is restricted. More specifically, the roller groove 26 functions as a guide means for causing linear displacement of the displacement body 28 via the pair of rollers 30, and also functions as a rotational displacement prevention means for restricting rotational displacement of the displacement body 28.

The toggle link mechanism 16 includes a link arm 46, which is pivotally supported together with the rollers 30 on the upper part of the displacement body 28, and which converts linear motion of the feed screw shaft 36 into rotary movement of the clamp arm 20. One end of the link arm 46 is pivotally supported on an upper end part of the displacement body 28, whereas the other end thereof is pivotally supported on an upper corner portion of the clamp arm 20 in the clamped state (see FIG. 3).

The clamp arm 20 is formed, for example, with a substantially rectangular shape in cross section, a lower corner portion of one end of the clamp arm 20 being supported rotatably with respect to the body 12 through a support pin 48, and the link arm 46 being pivotally supported on an upper corner portion above the aforementioned lower corner portion.

Further, a penetrating hole 50 is formed in the other end portion of the clamp arm 20 substantially parallel with a side surface of the clamp arm 20. An adjustment mechanism 52, which is capable of maintaining the clamping force substantially constant when a workpiece W is clamped, is disposed in the interior of the penetrating hole 50.

The adjustment mechanism 52 includes a rod (pressing body) 54 disposed displaceably in the penetrating hole 50, and a spring 56 interposed between the rod 54 and a step of the penetrating hole 50. An elastic force of the spring 56 urges the rod 54 toward a lower end surface side of the clamp arm 20.

A distal end of the rod 54 is formed in a hemispherical shape, and in a clamped state in which the clamp arm 20 is rotated, the end of the rod 54 is disposed in confronting relation to the gripping section 24 of the support member 22 (see FIG. 3).

The electric clamp apparatus 10 according to the first embodiment of the present invention is constructed basically as described above. Next, operations and advantageous effects of the electric clamp apparatus 10 shall be described. In the following description, an unclamped state, as shown in FIG. 1, shall be treated as an initial position. In the initial position, the distal end of the rod 54, which is mounted inside the clamp arm 20, is positioned substantially perpendicular with respect to the gripping section 24 of the support member 22, and the link arm 46 is arranged along a substantially straight line with the displacement body 28.

At first, in the initial position of the electric clamp apparatus 10 shown in FIG. 1, by inputting an electric signal from a non-illustrated controller with respect to the rotary drive source 32 of the rotary drive unit 14, the rotary drive source 32 rotates the drive shaft 34, and the drive pulley 38 is rotated along with the drive shaft 34. Additionally, upon rotation of the drive pulley 38, the driven pulley 40, around which the transmission belt 42 is trained, also rotates, and the feed screw shaft 36 rotates in unison with the driven pulley 40. By rotation of the feed screw shaft 36, as shown in FIG. 3, the displacement body 28 moves upwardly (in the direction of the arrow B) while being guided by the rollers 30 with respect to the roller groove 26. Along therewith, the link arm 46 starts to rotate clockwise about the location where the link arm 46 is pivotally supported on the displacement body 28, and the clamp arm 20 is rotated clockwise through a predetermined angle about the support pin 48.

In addition, upon further driving of the rotary drive unit 14 and under a rotary action of the feed screw shaft 36, the displacement body 28 moves further upward (in the direction of the arrow B), accompanied by rotation of the clamp arm 20 upon tilting movement (inclination) of the link arm 46. Consequently, the rod 54 of the clamp arm 20 comes into abutment against the workpiece W, and as shown in FIG. 3, a clamped state is brought about in which the workpiece W is gripped and retained between the rod 54 and the support member 22 of the body 12.

At this time, the rod 54 moves in an axial direction corresponding to a difference between the elastic force of the spring 56 and the clamping force (gripping force) applied when the workpiece W is clamped. More specifically, in the case that the elastic force of the spring 56 is large in relation to the clamping force of the clamp arm 20, since the elastic force of the spring 56 overcomes the clamping force, the workpiece W is clamped between the distal end of the rod 54 and the gripping section 24 of the support member 22, without causing the rod 54 to move substantially along the penetrating hole 50.

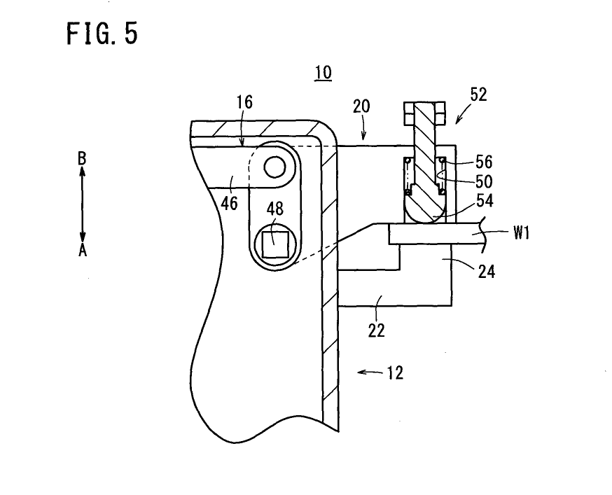

On the other hand, as shown in FIG. 5, in contrast to the aforementioned workpiece W, in the case that a workpiece W1 having a large thickness is clamped, when the rod 54 abuts against the workpiece W1, the rod 54 is pressed toward the side of the penetrating hole 50 by the gripping force of the clamp arm 20, and clamps the workpiece W1 in a condition of being moved by a predetermined distance in a direction away from the support member 22.

In the foregoing manner, according to the present embodiment, in the electric clamp apparatus 10 equipped with the toggle link mechanism 16, the adjustment mechanism 52 having the rod 54, which is biased by the elastic force of the spring 56, is provided on the other end of the clamp arm 20 that grips the workpieces W, W1. Accordingly, by advancing and retracting operations of the rod 54 with respect to the clamp arm 20, for example, even in the case of workpieces W, W1 having different plate thicknesses, by movement of the rod 54 corresponding to the thickness thereof, clamping of such workpieces W, W1 can be performed reliably and stably, without any need for adjusting the toggle link mechanism 16 each time that the workpiece plate thickness is changed.

Stated otherwise, when the workpieces W, W1 are clamped by the electric clamp apparatus 10, workpieces W, W1 of different plate thicknesses, ranging from thin plates to thick plates, can be clamped reliably and stably without performing any adjustment operations on the toggle link mechanism 16.

Further, since the clamp arm 20 is rotated by the drive force of the rotary drive unit 14, which is driven by an electric signal, high precision operations of the clamp arm 20 are enabled, and clamping of workpieces W, W1 can be performed with increased accuracy.

The electric clamp apparatus according to the present invention is not limited to the aforementioned embodiment, and it is a matter of course that various additional or modified structures may be adopted therein without deviating from the essential gist of the present invention.

1. An electric clamp apparatus for gripping a workpiece with a rotary clamp arm, comprising:
a body;
a drive unit which is driven rotatably by an electric signal;
a transmission mechanism for transmitting a rotary drive force of the drive unit;
a feed screw mechanism for converting rotational motion transmitted by the transmission mechanism into linear motion;
a toggle link mechanism for converting the linear motion transmitted by the feed screw mechanism into a rotary operation of the clamp arm; and
an adjustment mechanism for adjusting a clamping position by the clamp arm corresponding to a thickness of the workpiece.

2. The electric clamp apparatus according to claim 1, wherein the adjustment mechanism includes a pressing body disposed on the clamp arm, and which is urged by a pressing force toward a side of the workpiece, the workpiece being clamped between the clamp arm and the body through the pressing body.

3. The electric clamp apparatus according to claim 1, wherein in the toggle link mechanism, a link arm interconnecting the clamp arm and a displacement body of the feed screw mechanism is retained in a direction perpendicular to a direction of movement of the displacement body.

4. The electric clamp apparatus according to claim 2, wherein the adjustment mechanism includes an elastic member that imposes the pressing force with respect to the pressing body.

5. The electric clamp apparatus according to claim 2, wherein the pressing body is disposed displaceably in a hole formed on an end of the clamp arm.
